(19) United States
(12) Patent Application Publication
(10) Pub. No.: US 2002/0055857 A1
(43) Pub. Date: May 9, 2002

(54) Method of assisting individuals in lifestyle control programs conducive to good health

(76) Inventor: James R. Mault, Evergreen, CO (US)

Correspondence Address: Allen M. Krass, GIFFORD, KRASS, GROH, SPRINKLE,, ANDERSON & CITKOWSKI, P.C., 280 N. Old Woodward, Suite 400, Birmingham, MI, 48009, US

(21) Appl. No.: 10/033,063

(22) Filed: Oct. 25, 2001

Related U.S. Application Data
(60) Provisional application No. 60/244,468, filed on Oct. 31, 2000.

(51) Int. Cl. G06F 17/60

(52) U.S. Cl. 705/2

(57) ABSTRACT

A method of assisting a person in a lifestyle control program conducive to good health, by storing in a database lifestyle data from a statistically large group of persons, and the correlation of such lifestyle data to good health; collecting, in a personal logging device for the person, corresponding lifestyle data of the respective person; feeding the collected lifestyle data from the personal logging device of the person to the database; performing a statistical analysis of the lifestyle data collected from the respective person, with respect to said lifestyle data of the group stored in the database, to produce an output including correlations of the lifestyle data collected from respective persons to good health; and feeding back to the person health-promoting information based on the correlations.

### RELATED APPLICATION

The present application is related to provisional application No. 60/244,468, filed Oct. 31, 2000, hereby incorporated by reference, and claims the priority date of that application.

### FIELD AND BACKGROUND OF THE INVENTION

The present invention relates to a method of assisting individuals in lifestyle control programs, and particularly to assisting individuals in lifestyle control programs conducive to good health.

It is known as part of weight control and/or health maintenance systems to equip a person with a diet logger, namely, a device which records food types and food quantities consumed or intended to be consumed. The diet logger may be a PDA (personal digital assistant, or personal dieting assistant); however, other portable electronic devices or systems may be used.

More generally, a lifestyle logger (or lifestyle monitor) has one or more of the following functionalities: diet logger, activity logger, environmental logger, and/or physiological logger. For convenience, the term PDA is used herein to refer to a lifestyle logger (e.g. a diet logger), a physiologic monitor (including weight monitor, metabolic rate monitor), an activity monitor, an environmental logger, etc. The PDA may be in communication with, or receive data from, the user, via any method, including manual data entry (but preferably using wireless communication such as Bluetooth or IR methods, or memory card transfer), various sensors, transducers, and/or supplemental devices so as to obtain information needed for lifestyle logging. For example, metabolic rate may be obtained using an indirect calorimeter, and the data entered into the PDA as part of a weight control program. The PDA may also download information from external databases or devices via a communications network such as the Internet.

### OBJECTS AND BRIEF SUMMARY OF THE PRESENT INVENTION

An object of the present invention is to provide a method utilizing such a PDA, or other personal logging device, for assisting an individual in a lifestyle control program conducive to good health.

According to one broad aspect of the present invention, there is provided a method of assisting an individual in a lifestyle control program conducive to good health, comprising: storing in a database lifestyle data from a statistically large group of persons, and the correlation of such lifestyle data to good health; collecting, in a personal logging device for the person, corresponding lifestyle data of the respective person; feeding the collected lifestyle data from the personal logging device of the person to the database; performing a statistical analysis of the lifestyle data collected from the respective person, with respect to the lifestyle data of the group stored in the database, to produce an output including correlations of the lifestyle data collected from respective persons to good health; and feeding back to the person health-promoting information based on the correlations.

According to further features in the preferred embodiments of the invention described below, the health-promoting information is fed back to the individual via the personal logging device of the individual. In addition, the database is located at a remote location from the personal logging device and communicates therewith via a communication channel, such as the Internet.

According to further features in the preferred embodiments described below, the lifestyle data collected in the personal logging device includes diet data as to the food types and quantities consumed or to be consumed by the respective person.

A variety of methods can be used to record the food types and food quantities eaten, for example, a barcode reader, optical character recognition, manual entry, imaging, spectroscopic imaging, electronic noses, etc. For example, the PDA may use an optical sensor array and optical character recognition software to obtain product identity and information from packages, menus, and receipts. The PDA may be scanned across or held close to words on prepackaged foods to determine the identity and nutrition information of the food. Methods of determining portion size include imaging, with dimensional analysis, scales in communication with the PDA, manual data entry, scales built into the PDA, measuring inertial properties, measuring ultrasonic impedance, etc.

The PDA may thus be used to monitor physical activity of the person, e.g. using a body-mounted accelerometer (e.g. a pedometer). Other inputs to the PDA include questioning the person about his or her prior illnesses, current medications, activities, inputs from a fitness trainer, communication with one or more additional activity sensors, etc.

As part of a health maintenance program, PDAs are provided to a group of persons. The term “health maintenance program” includes weight control programs, weight loss programs, fitness programs, patient recovery programs, etc. In one preferred embodiment, a person is provided with a lifestyle logger as part of a weight control program, so that the lifestyle logger is a diet logger, activity logger, and weight logger. Providing a lifestyle logger may mean providing the person with hardware (e.g. a Palm Pilot) with pre-mounted software, providing hardware and access to software e.g. downloadable over the Internet, providing software for the person to run on their own hardware, or providing some combination of software, hardware modifications or accessories. Providing a lifestyle logger may also mean selling, renting, or leasing the lifestyle logger to the person, or in some cases providing the lifestyle logger as part of a subscription program, in which case the lifestyle logger may be included for free or for a discounted price, e.g. for a minimum subscription period.

A person preferably records diet and body weight data, and possibly also activity level data, physiological parameters over time, environmental parameters over time, etc. using the lifestyle logger (referred to also here as a PDA). This information is transmitted to a remote database (i.e. a database not in the PDA), where it can be accessed by any authorized person. Authorized people may include physicians, dieticians, weight control counselors, fitness consultants, etc. The data on the database may also be accessed by computer expert systems or statistical analysis software. A wireless Internet connection may be used to transmit data to the remote database. The data collected is used to provide feedback to the persons. For example, in a weight loss program, dietary changes may be suggested if weight loss goals are not met.

According to further features in the described preferred embodiments, the lifestyle data collected in the personal logging device further includes energy expenditure data as to the energy expended or to be expended by the respective person. Preferably, such energy data includes a measurement of the energy expended by the resting metabolism of the person, and a measurement of the energy expended by physical activities of the person. In the described preferred embodiment, the resting metabolism is measured by an indirect calorimeter applied to the person, and the energy expended by physical activities is measured by a physical activity sensor applied to the person.

According to further preferred features in the described preferred embodiments, the lifestyle data collected in the personal logging device further includes personal health data including the age, gender, weight and height of the respective person. Such personal health data may include prior illnesses of the person, and current medications taken by the person. It may also include genetic information of the person, which genetic information may be helpful in indicating future health risks, or making predictions as to the future health, of the respective person.

Other lifestyle data which may be collected may relate to environmental conditions, such as temperature, humidity, pressure, radiation level, possible chemicals in the atmosphere, etc., any of which environmental conditions may also affect the future health of the person.

Further features and advantages of the invention will be apparent from the description below.

### BRIEF DESCRIPTION OF THE DRAWINGS

The invention is herein described, by way of example only, with reference to the accompanying drawings, wherein:

FIG. 1 is a block diagram illustrating one form of system constructed in accordance with the present invention for assisting an individual in a lifestyle control program conducive to good health;

FIG. 2 is a block diagram more particularly illustrating the activity log unit in the system of FIG. 1; and

FIG. 3 is a flowchart illustrating one manner of using the described system for assisting an individual in a lifestyle control program conducive to good health.

### DESCRIPTION OF A PREFERRED EMBODIMENT

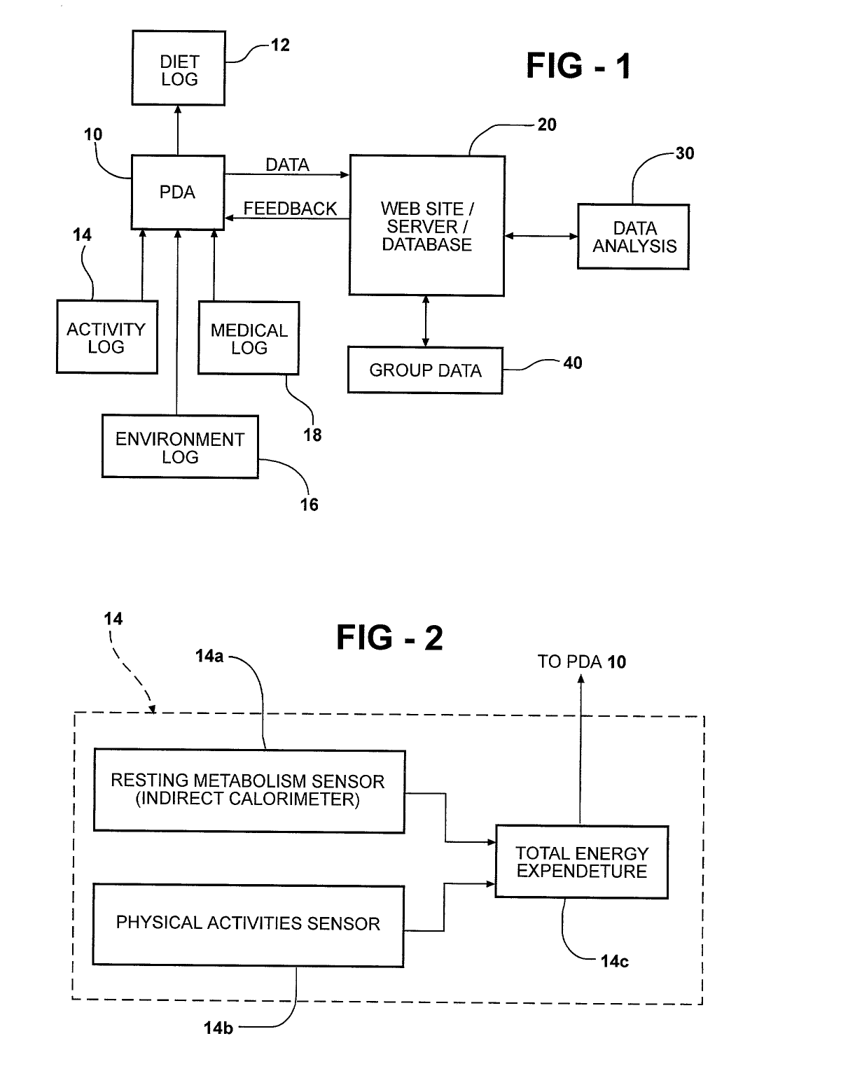

FIG. 1 illustrates a system embodiment of the present invention. PDA 10 collects dietary data using a diet log 10, an activity log 14, an environmental log 16, and a medical log 18. The data collected by such logs will be collectively referred to as lifestyle data.

This lifestyle data is transmitted to a database in a remote computer system 20. The data is combined with data from other members of the group (group data) 40. Data analysis software 30 is used to find trends and correlations within the collected data. The results of data analysis are used to provide individualized feedback to the person, or generalized information to the group.

The activity log 14 is preferably software running on the PDA, which collects data from a body mounted accelerometer, or accelerometers in the PDA, or from the user via a suitable interface. FIG. 2 illustrates one example of such an activity log 14. Thus, as shown in FIG. 2, the activity log 14 includes a resting metabolism sensor 14a, preferably an indirect calorimeter; and a physical activity sensor 14b, both applied to the respective person. The outputs of the two sensors 14a, 14b are added together to produce a total energy expenditure, as shown by block 14c, before being fed to the PDA 10.

The environmental log 16 may receive data from an air pollution sensor, other environmental sensor, or from a website providing such information. Information from websites may be provided directly to server 20. The medical log 18 is used to record medication taken. Remote computer system 20 is preferably a server system, having access to memory for database storage, and having access to a communications network for the provision of a website.

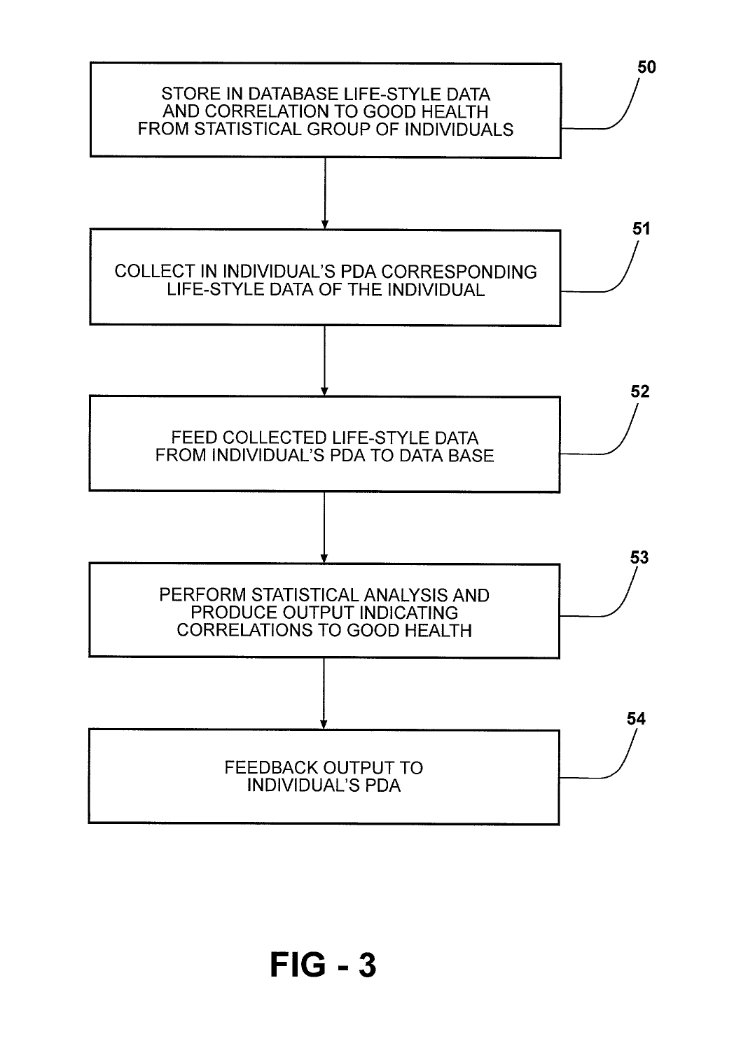

FIG. 3 is a flowchart illustrating one manner of using the system of FIGS. 1 and 2 for assisting an individual in a lifestyle control program conductive to good health.

Thus, as shown in FIG. 3, the database 20 is used for storing lifestyle data and correlations to good health from a group of such persons or individuals sufficiently large to constitute a statistical group (block 50).

The lifestyle data of the respective individual person is collected in the individual's PDA as shown in FIG. 1 and as briefly described above (block 51). This collected lifestyle data is fed from the individual's PDA 10 to the database 20 (block 52).

A computer at the site of the database 20, or at a site communicating with the database, then performs a statistical analysis of the collected lifestyle data with respect to the lifestyle data stored in the database 20, and produces an output indicating correlations to good health (block 53). Such an output is then fed back to the individual PDA (block 54), to thereby assist the individual in a lifestyle control program conducive to good health.

The lifestyle data stored on remote computer system 20 in a database may be supplemented by other information, e.g. additional data known about members of the group from other sources (e.g. registration information when they signed up for the weight loss program, other purchase pattern information, or other lifestyle information) or lifestyle data from other groups.

Collected lifestyle data from the group can be analyzed for trends and correlations. For example, weight loss or weight control may be more successful in groups eating or avoiding certain types or categories of food. This may be correlated with demographic data. For example, middle-aged people drinking large quantities of soda may be less successful in weight control programs. Hence, specific feedback may be provided to soda-drinking middle-aged people, suggesting a lower soda consumption or alternative drinks.

Over an extended period of time, the people in the group may experience diverse health problems and diseases. Health information is collected and statistical analysis performed to relate the relationship of health with lifestyle data. Genetic information, if available, is included in the analysis, for example if the parents of a person had a disease. Demographic information, such as age, gender, and the like, is also included in the analysis. Additional physiological and environmental data is included, if available. For example, people who frequently fly may have an ionizing radiation detector built into a PDA or otherwise in communication with it, so increased exposure to ionizing radiation at high altitudes may be included. People working with chemicals may use sensors to monitor exposure. Such sensor/PDA systems may be provided to a person by employers, employee organizations, trade organizations, insurers, or other sources.

A large group of people sends data to the database 20, so that meaningful correlations can be found between diet, environment, activity levels, physiological parameters, and health; more generally between lifestyle data and health. Preferably, correlations are performed on data from which individual identity has been removed, preserving privacy. If desired, a person can ask for a risk analysis based on his or her own data to be performed. Preferably, this will only be done with the permission of that person.

This system can also be combined with analysis of genomic or genetic data. A person may be provided with sensors which detect certain gene sequences, or genetic sequencing may be performed on a sample from the person. The collected genomic data, in combination with extensive dietary and environmental data logging, provides an immensely powerful method of predicting risk factors for members of the group. For example, it may be revealed by statistical analysis that low levels of fruit intake, combined with a certain genetic marker, leads to higher than average levels of colon cancer. This is a statistical correlation and would enable such a feedback to be provided. In this case, people with low fruit intake may be contacted and tested for the genetic marker. If present, those people would then be encouraged to eat higher levels of fruit and be tested regularly for colon cancer.

Certain genetic markers may indicate a predisposition to certain foods of poor nutritional content. Genomic sequencing can then be used to warn a person against these predispositions.

Genetic markers and sequences can also be used to predict the effect of exercise on a person's metabolic rate. An exercise program can be devised for maximum effect on weight loss for a reasonable effort on the person's part, based on their genetic predisposition.

Purchase information data can also be advantageously used in compiling lifestyle data. For example, food purchase data can be provided to a person to assist the person with diet logging.

Many grocery stores provide discount programs by which shoppers receive small price discounts in return for allowing the store to compile an extensive database of their purchasing habits. These schemes are very popular. The collected purchase data can also be used by a person in compiling a diet log. For example, the nutrition information for a particular brand of ice cream purchased by the person can be used in place of a generic ice cream diet log entry. Portion sizes can be estimated from the number of servings obtained from a purchased package. Hence, a grocery store can also function as a health management advisor to the shopper, either as a single entity or in collaboration with a separate health management business. Diet log data for a person is analyzed, and nutrition deficiencies are identified. Purchase suggestions, coupons, and the like are then provided to the person so as to adjust his or her purchasing patterns towards a healthier lifestyle.

In another embodiment, when a person purchases items, data related to the purchased items may be uploaded to a remote server system. Items for which nutritional data is not included may be flagged to cause an administrator or software program to add appropriate data for later downloading. The nutritional data may be used in creating a diet log for the person.

A grocery store may provide a shopper with an identity card, a wireless transmitter, or some other identification means. As a shopper with wireless identification walks past a display, individualized feedback can be provided. For example, lights may flash near a food of recommended nutrition content, foods usually purchased, alternatives to foods usually purchased, foods with discounts available, and the like. Audio signals may also be used to communicate with an identified customer. For example, a food display may announce: “Customer #6, stop eating unhealthy beef jerky strips and try this new healthy celery-flavored yogurt. For you, this is 20% off.” Customized discounts may be offered to encourage sales or appropriate nutrition.

Grocery shopping via a communications network, for example on-line grocery shopping allows very detailed feedback to be conveniently provided to a shopper during purchase. For example, a person ordering an unhealthy food may be provided with a graphical illustration of the enhanced illness rates of previous customers after eating that item regularly. Likewise, promotion of a new item can be achieved by illustrating the determined health benefits of similar foods or component ingredients.

A person may carry a PDA with GPS or other location-determining functionality. Diet advice can then be made on a location-dependent basis. The PDA may provide dietary advice related to location, altitude, climate, or other environmental factors. For example, a restaurant nearby may be recommended as providing healthy food. The PDA may also function as a location-based guidebook, in which the person's known location is used to provide tourist, disease, hotel, travel, or other useful information.

For eating at a restaurant, a user can enter what was eaten at the specified restaurant. An administrator or other employee of a health maintenance organization can determine nutrition by contacting the restaurant, and may offer listing in a database and a benefit to the restaurant. The nutrition content of the meal may also be estimated knowing the item ordered and the identity of the restaurant. A health maintenance organization may provide a user with a PDA having a stored database of restaurants, these restaurants providing nutrition information on meals consumed.

As people age, their consumption and lifestyle patterns may change in predictable patterns. These patterns may be determined by statistical analysis of collected lifestyle data. For example, persons of a certain demographic group may buy one type or brand of beverage, cereal, dessert, etc. while under 40, then migrate to a second brand at later ages. This determined pattern may then be used to market the second brand to older members of the demographic group. Also, persons consuming one type of food may be statistically more likely to perform a certain type of activity, as recorded by diet and activity logs. This correlation may be used to market activity-related products to consumers of that type of food.

Changes in diet and activity logs for a person may be used to diagnose physical and psychological ailments, and hence to provide appropriate feedback and advice.

The PDA may use seasonal trends in suggesting diet and exercises. For example, swimming may be suggested in preference to running if the temperature is to fall below a certain value. Weather forecasts may be obtained over a communications network, or typical values obtained from a database.

The PDA can also be used to collect the feelings or described symptoms of the person, for example tiredness, headaches, and the like. Correlations with the collected diet log data can be used to suggest avoiding certain foods in the future.

Feedback to the PDA may adapt to the wishes of the person. For example, new age remedies may be suggested if appropriate.

The PDA used by the person in diet logging will alert the person to dietary deficiencies, and suggest supplements. The PDA used in diet logging can also be used to assist food purchases, suggest nutritionally balanced meals and recipes, provide advice to the person related to specific medical conditions (such as ageing, pregnancy, illness), advise on medicine conflicts, warn of foods or ingredients to which the person is allergic, and suggest alternative foods to those planned to be consumed.

Voice recognition software on the PDA may be used to enter lifestyle-related data. Audio files may also be recorded by the PDA, transmitted to a remote computer over a communications network, and then analyzed by the remote computer, for example to create a diet log from recorded memos. Purchase information may also be used in creating the diet log.

Accordingly, while the invention has been described with respect to several preferred embodiments, it will be appreciated that these are set forth merely for purposes of example, and that many other variations, modifications and applications of the inventions may be made.

What is claimed is:

1. A method of assisting a person in a lifestyle control program conducive to good health, comprising:
storing in a database lifestyle data from a statistically large group of persons, and the correlation of such lifestyle data to good health;
collecting, in a personal logging device for the person, corresponding lifestyle data of the respective person;
feeding said collected lifestyle data from said personal logging device of the person to said database;
performing a statistical analysis of said lifestyle data collected from the respective person, with respect to said lifestyle data of said group stored in said database, to produce an output including correlations of said lifestyle data collected from respective persons to good health; and
feeding back to said person health-promoting information based on said correlations.

2. The method according to claim 1, wherein said health-promoting information is fed back to said person via said personal logging device of the person.

3. The method according to claim 1, wherein said database is located at a remote location from said personal logging device and communicates therewith via a communication channel.

4. The method according to claim 1, wherein said database communicates with said personal logging device via a communication channel and feeds back said individual health-promoting information to said person via said personal logging device.

5. The method according to claim 4, wherein said communication channel is the Internet.

6. The method according to claim 1, wherein said lifestyle data collected in said personal logging device includes diet data as to the food types and quantities consumed or to be consumed by the respective person.

7. The method according to claim 6, wherein said lifestyle data collected in said personal logging device further includes energy expenditure data as to the energy expended or to be expended by the respective person.

8. The method according to claim 7, wherein said energy expenditure data includes a measurement of the energy expended by the resting metabolism of the person, and a measurement of the energy expended by physical activities of the person.

9. The method according to claim 8, wherein said resting metabolism is measured by an indirect calorimeter applied to the person, and said energy expended by physical activities is measured by a physical activity sensor applied to the person.

10. The method according to claim 6, wherein said lifestyle data collected in said personal logging device further includes personal health data including the age, gender, weight and height of the respective person.

11. The method according to claim 10, wherein said personal health data further includes prior illnesses of the individual and medications being taken by the person.

12. The method according to claim 10, wherein said personal health data further includes genetic information of the respective person.

13. The method according to claim 6, wherein said lifestyle data collected in said personal logging device further includes environmental data regarding various environmental conditions of the respective person.

14. The method according to claim 1, wherein said output produced as a result of said statistical analysis also includes an indication of future health risks of the respective person.

15. A method of providing health and lifestyle advice to a person, comprising the steps of:
(a) providing the person with a lifestyle logging device;
(b) collecting lifestyle data from the person,
(c) storing the lifestyle data in a database;
(d) collecting health related data from the person;
(e) performing steps (a)-(d) for other persons within a group of persons;
(f) determining statistical correlations between the lifestyle data and the health data to good health for the group of persons; and
(g) providing feedback to the person based on said statistical correlations;
whereby statistical correlations between lifestyle data and health data for the group of persons is used to provide feedback and advice to the person.

16. A method of providing health and lifestyle advice to a person, within a group of persons, comprising:
collecting lifestyle data from the group of persons and storing it in a database;
collecting health data from the group of persons;
collecting genomic data from the group of persons;
performing a statistical analysis of the health data in relation to the lifestyle data and the genomic data, so as to determine statistical correlations between the genomic data, the lifestyle data and the health data; and
providing advice to persons within the group of persons based on the statistical correlations;
whereby persons at high risk of disease or other health problems, based on the statistical analysis, are provided with advice on lifestyle changes which would be statistically effective in reducing health risks.

17. The method of claim 16 further comprising the inclusion of health data, lifestyle data, and genomic data from another group of persons into the statistical analysis used to provide advice and feedback to the group of persons.

18. A health maintenance method directed towards a person, comprising the steps of:
providing the person with a lifestyle logger for the collection of lifestyle data related to the person;
providing the person with access to a remote computer system, so as to collect lifestyle data from the person; and
providing suggested lifestyle changes to the person based on the collected lifestyle data, so as to statistically reduce health risks.

19. A method for predicting health risks of a person, within a group of persons, comprising the steps of:
providing each person with a lifestyle logger;
providing a communications link between each lifestyle logger and a computer system, whereby lifestyle data related to each person is accessible to the computer system;
monitoring health data related to a plurality of persons within the group of persons;
determining statistical correlations between the collected lifestyle data and the monitored health data; and
using the determined statistical correlations to provide advice to persons within the group of persons.

20. The method of claim 19 further comprising collecting genomic data from persons within the group of persons; and performing statistical analysis of the health of the persons in relation to the lifestyle data and the genomic data, whereby lifestyle data and genomic data may be used to predict the health of a person.
